(19) United States
(12) Patent Application Publication
(10) Pub. No.: US 2001/0043395 A1
(43) Pub. Date: Nov. 22, 2001

(54) Single lens 3D software method, system, and apparatus

(76) Inventor: Bryan L. Costales, Boulder, CO (US)

Correspondence Address: Douglas W. Swartz, SHERIDAN ROSS P.C., Suite 1200, 1560 Broadway, Denver, CO, 80202-5141, US

(21) Appl. No.: 09/775,887

(22) Filed: Feb. 2, 2001

Related U.S. Application Data
(60) Provisional application No. 60/180,038, filed on Feb. 3, 2000.

(51) Int. Cl. G06T 15/30; G06T 17/20; G02B 27/22

(52) U.S. Cl. 359/464; 345/423

(57) ABSTRACT

A method, system, and apparatus is disclosed for producing enhanced three dimensional effects. The invention emulates physical processes of focusing wherein objects in the foreground and the background are in varying degrees out-of-focus and represented differently to each of a viewer's eyes. In particular, the invention divides out-of-focus light sources so that different partitions of such a division are viewed by a viewer's right eye as compared to what is viewed by the viewer's left eye. Thus, the invention interposes novel processing between a determination as to what to render in a synthetically produced three dimensional space and the actual rendering thereof, wherein the novel processing produces stereoscopic views from a two dimensional view by utilizing information about the relation of light sources in the three dimensional space to the in-focus plane in the space.

### CROSS REFERENCE TO RELATED APPLICATION

The present application claims the benefits under 35 U.S.C. §119 of U.S. Provisional Patent Application Ser. No. 60/180,038, filed Feb. 3, 2000, entitled ASINGLE-LENS 3D SOFTWARE METHOD, SYSTEM AND APPARATUS@, to Costales and Flynt, which is incorporated herein by this reference. The present application is also related to U.S. patent application Ser. No. 09/354,230, filed Jul. 16, 1999; U.S. Provisional Patent Application Ser. No. 60/166,902, filed Nov. 22, 1999; U.S. patent application Ser. No. 09/664,084, filed Sep. 18, 2000; and U.S. Provisional Application Ser. No. 60/245,793, filed Nov. 3, 2000; and U.S. Provisional Patent Application Ser. No. 60/261,236, filed Jan. 12, 2000; U.S. Provisional Patent Application Ser. No. 60/190,459, filed Mar. 17, 2000; and U.S. Provisional Application Ser. No. 60/222,901, filed Aug. 3, 2000, all of which are incorporated herein by reference.

### BACKGROUND OF THE INVENTION

Many methods, systems, and apparatuses have been disclosed to provide computer generated graphical rendering scenes wherein depth information for objects in the scenes is used as a part of the software generation of the scene. Among the techniques in common use are:

(a) shadowing to convey background depth, wherein shadows cast by objects in the scene provide the viewer with information as to the distance to each object,

(b) smearing to simulate foreground and background out-of-focus areas, and

(c) computed foreground and background out-of-focus renderings modeled on physical principles such as graphical representations of objects in a foggy scene as in U.S. Pat. No. 5,724,561.

It is further known that there are graphics systems which provide a viewer with visual depth information in scenes by rendering 3D or stereoscopic views, wherein different views are simultaneously (i.e., within the limits of persistence of human vision) presented to each of the viewer's eyes. Among the techniques in common use for such 3D or stereoscopic rendering are edge detection, motion following, and completely separately generated ocular views.

Note that the scenes rendered by the techniques (a)-(c) above give a viewer only indications of scene depth, but there is no sense of the scenes being three dimensional due to a viewer's eyes receiving different scene views as in stereoscopic rendering systems. Alternatively, the 3D or stereoscopic graphic systems require stereoscopic eye wear for a viewer.

In other scene viewing systems, three dimensional effects can be created from a two dimensional scene by modifying the aperture stop of a lens system so that the aperture stop is vertically bifurcated to yield, e.g., different left and right scene views wherein a different one of the scene views is provided to each of the viewer's eyes. In particular, the effect of bifurcating the aperture stop vertically causes distinctly different out-of-focus regions in the background and foreground display areas of the two scene views, while the in-focus image plane of each scene view is congruent (i.e., perceived as identical) in both views. One of the advantages of this physical method is that it produces an image the can be viewed comfortably in 2D without eye-wear and in 3D with eye-wear. One of the advantages of modeling this physical method with a software method is that animated films can be created which can also be viewed comfortably in 2D without eye-wear and in 3D with eye-wear. It would be desirable to have a simple graphical rendering system that allows a viewer to clearly view the same scene or presentation with or without stereoscopic eye wear, wherein techniques such as (a)-(c) above may be presented differently depending on whether the viewer is wearing stereoscopic eye wear or not. In particular, it would be desirable for the viewer to have a more pronounced sense of visual depth in the scene or presentation when such stereoscopic eye wear used.

### SUMMARY OF THE INVENTION

The present invention is a method and apparatus for allowing a viewer (also denoted a user herein) to clearly view the same computer generated graphical scene or presentation with or without stereoscopic eye wear, wherein techniques such as (a)-(c) above may be presented differently depending on whether the viewer is wearing stereoscopic eye wear or not. In particular, the present invention provides the user with a more pronounced sense of visual depth in the scene or presentation when such stereoscopic eye wear used, but the same scene or presentation can be concurrently and clearly viewed without such eye-wear.

The stereoscopic imaging techniques disclosed herein can be utilized with any image acquisition devices. For example, the techniques can be used with any of the imaging devices described in U.S. patent application Ser. No. 09/354,230, filed Jul. 16, 1999; U.S. Provisional Patent Application Ser. No. 60/166,902, filed Nov. 22, 1999; U.S. patent application Ser. No. 09/664,084, filed Sep. 18, 2000; and U.S. Provisional Application Ser. No. 60/245,793, filed Nov. 3, 2000; and U.S. Provisional Patent Application Ser. No. 60/261,236, filed Jan. 12, 2000; U.S. Provisional Patent Application Ser. No. 60/190,459, filed Mar. 17, 2000; and U.S. Provisional Application Ser. No., 60/222,901, filed Aug. 3, 2000, all of which are incorporated herein by reference. In the event that the acquired image is in analog form, any number of known processes may be employed to digitize the image for processing using the techniques disclosed herein.

To further facilitate a greater appreciation and understanding of the present invention, the following U.S. patents are incorporated herein by this reference:

U.S. Pat. No. 3,665,184 May 1972 Schagen 378/041

U.S. Pat. No. 4,189,210 Feb. 1980 Browning 359/464

U.S. Pat. No. 4,835,712 May 1989 Drebin 345/423

U.S. Pat. No. 4,901,064 Feb. 1990 Deering 345/246

U.S. Pat. No. 4,947,347 Aug. 1990 Sato 345/421

U.S. Pat. No. 5,402,337 Mar. 1995 Nishade 345/426

U.S. Pat. No. 5,412,764 May 1995 Tanaka 345/424

U.S. Pat. No. 5,555,353 Sep. 1996 Shibazaki 345/426

U.S. Pat. No. 5,616,031 Apr. 1997 Logg 434/038

U.S. Pat. No. 5,883,629 Jun. 1996 Johnson 345/419

U.S. Pat. No. 5,724,561 Mar. 1998 Tarolli 345/523

U.S. Pat. No. 5,742,749 Apr. 1998 Foran 345/426

U.S. Pat. No. 5,798,765 Aug. 1998 Barclay 345/426

U.S. Pat. No. 5,808,620 Sep. 1998 Doi 345/426

U.S. Pat. No. 5,809,219 Sep. 1998 Pearce 345/426

U.S. Pat. No. 5,838,329 Nov. 1998 Day 345/426

U.S. Pat. No. 5,883,629 Mar. 1999 Johnson 345/419

U.S. Pat. No. 5,900,878 May 1999 Goto 345/419

U.S. Pat. No. 5,914,724 Jun. 1999 Deering 345/431

U.S. Pat. No. 5,926,182 Jul. 1999 Menon 345/421

U.S. Pat. No. 5,936,629 Aug. 1999 Brown 345/426

U.S. Pat. No. 5,977,979 Nov. 1999 Clough 345/422

U.S. Pat. No. 6,018,350 Jan. 2000 Lee 345/426

U.S. Pat. No. 6,064,392 May 2000 Rohner 345/426

U.S. Pat. No. 6,078,332 Jun. 2000 Ohazama 345/426

U.S. Pat. No. 6,081,274 Jun. 2000 Shiraishi 345/426

U.S. Pat. No. 6,147,690 Nov. 2000 Cosman 345/431

U.S. Pat. No. 6,175,368 Jan. 2001 Aleksic 245/430

Further benefits and features of the present invention will become evident from the accompanying figures and the Detailed Description hereinbelow.

### BRIEF DESCRIPTION OF THE DRAWINGS

FIG. 1 illustrates that optically out-of-focus portions of a scene that are in the background do not differ from out-of focus portions of a scene that are in the foreground.

FIG. 2 shows that a single lens 3D produces out-of-focus areas that differ between the left and right views and between the foreground and background.

FIG. 3 shows that the method of the present invention can interpose a decision between the decision to render and the process of rendering.

FIG. 4 shows that the method cannot be circumvented.

FIG. 5 shows a logic diagram which describes the system and apparatus.

FIG. 6 is a programmatic representation of the advisory computational component 19 shown here in the C programming language.

FIGS. 7A and 7B is a flowchart showing, at a high level, the processing performed by the present invention.

FIG. 8 illustrates the division of a (model space) pixel's out-of-focus image extent (on the image plane), wherein this extent is divided vertically (i.e., traversely to the line between a viewer's eyes) into greater than two (and in particular four) portions for displaying these portions selectively to different of the viewer's eyes.

FIG. 9 illustrates a similar division of a (model space) pixel's out-of-focus image extent; however, the division of the present figure is horizontal rather than vertical (i.e., substantially parallel to the line between a viewer's eyes).

FIG. 10 illustrates a division of a (model space) pixel's out-of-focus image extent wherein the division of this extent is at an angle different from vertical (FIG. 8) and also different from horizontal (FIG. 9).

### DETAILED DESCRIPTION OF THE INVENTION

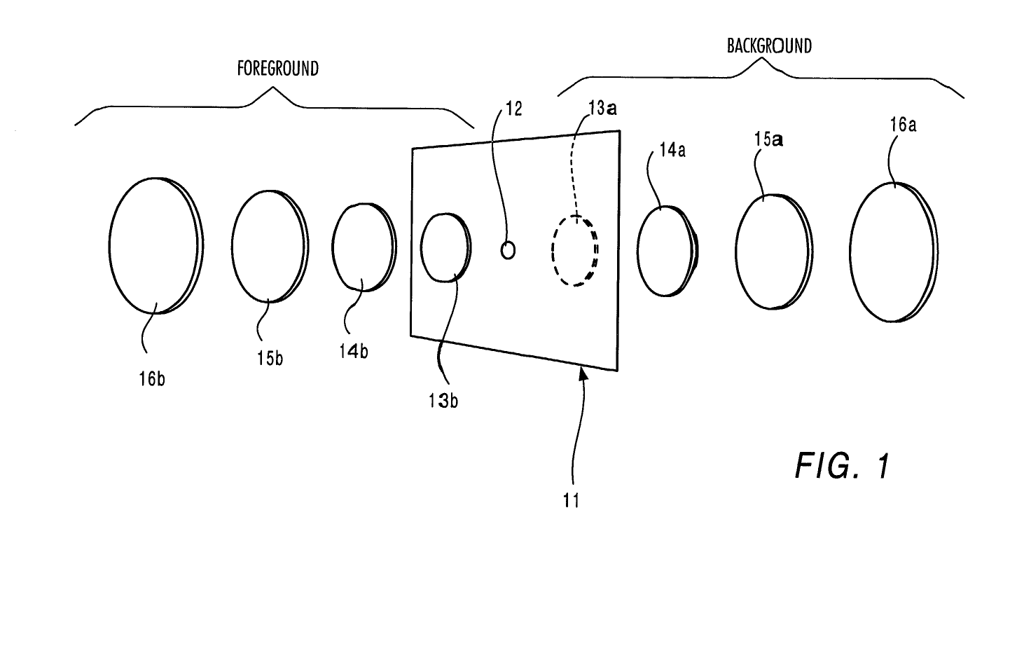

Given, e.g., a point light source (not shown, and more generally, an object) to be imaged by a lens system (not shown), FIG. 1 shows an in-focus image 12 of the point light source, wherein the image 12 is on an image plane 11. Other images of the point light source may be viewed on planes that are parallel to the image plane 11 but at different offsets from the image plane 11. Images 13A through 16B depict the images of the point light source on such offset planes (note, that these images are not shown their offset planes; instead, the images are shown in the plane of the drawing to thereby better show their size and orientation to one another). In particular, offset planes of substantially equal distance in the foreground and the background from the image plane have substantially the same out of focus image for a point light source. Moreover, given an object plane (not shown) which, by definition, is substantially normal to the aperture of the lens system, and contains the portion of the image that is in-focus on the image plane 11, a different point light source on the opposite side of the object plane from the lens system (i.e., in the “background” of a scene displayed on the image plane 11) will project to a point image (i.e., focus) ahead of the image plane 11 (i.e., on the side of the image plane labeled BACKGROUND). Thus, the image of such a background point on the image plane 11 will be out-of-focus. Alternatively, a point light source on the same side of the object plane (i.e., in the “foreground” of the scene displayed on the image plane 11) will project to a point image behind the image plane (i.e., on the side of the image plane labeled FOREGROUND). Thus, the image of such a foreground point light source in the image plane 11 will be similarly out-of-focus, and more particularly, foreground and background objects of a equal offset from the object plane will be substantially equally out of focus on the image plane 11. For example, the images 13A through 16B show the size of the representation of various point light sources in the foreground and the background as they might appear on the image plane 11 (assuming the point light sources for each image 13A and 13B are the same distance from the object plane, similarly for the pairs of images 14A and B, 15A and B, and, 16A and B).

When, a background or foreground point is out of focus, but insufficiently out-of-focus for the human eye to perceive it as out- of-focus, it is denoted herein as “physically out-of-focus”. Note that image points 13A and 13B are to be considered as only physically out of focus herein. When a background and foreground point is sufficiently out-of-focus for the human eye to perceive it as out-of-focus, it is denoted herein as “visually out-of-focus”. Note that images 14A through 16B are to be considered as visually out of focus herein. Furthermore, note that as a point in the three dimensional space (i.e., model or object space) moves further away from the object plane, its projections onto the image plane 11 becomes more and more out-of-focus on the image plane.

When a user is wearing eye wear (or is viewing a display-device that displays a different view to each eye) according to the present invention, wherein different digital images can be substantially simultaneously (i.e., within limits of image persistence of the human eye) presented to each of the user' eyes, the present invention provides an improved three dimensional effect by performing, at a high level, the following steps:

Step (a) determining an image, IM, of the model space wherein the image of each object in IM is in-focus regardless of its distances from the point of view of the viewer,

Step (b) determining an object plane coincident with the portion of model space 25 that will the in-focus plane,

Step (c) determining the out-of-focus image extent of each pixel in TM based on its distance from the object plane, and assign to each such pixel a value based on its being in front of or behind the object plane relative to the point of view of the viewer,

Step (d) dividing into two image portions, e.g., image halves, the image extent of each pixel determined in step (c) that is visually out-of-focus,

Step (e) for each pixel image extent divided in (d) into first and second halves:

(i) prohibiting the out-of-focus first image half from being viewed by a first of the user's eyes, while concurrently presenting this first image half to the second of the user's eyes, and

(ii) prohibiting the out-of-focus second image half from view by the second of the user's eyes, while presenting this second half image to the first of the user's eyes.

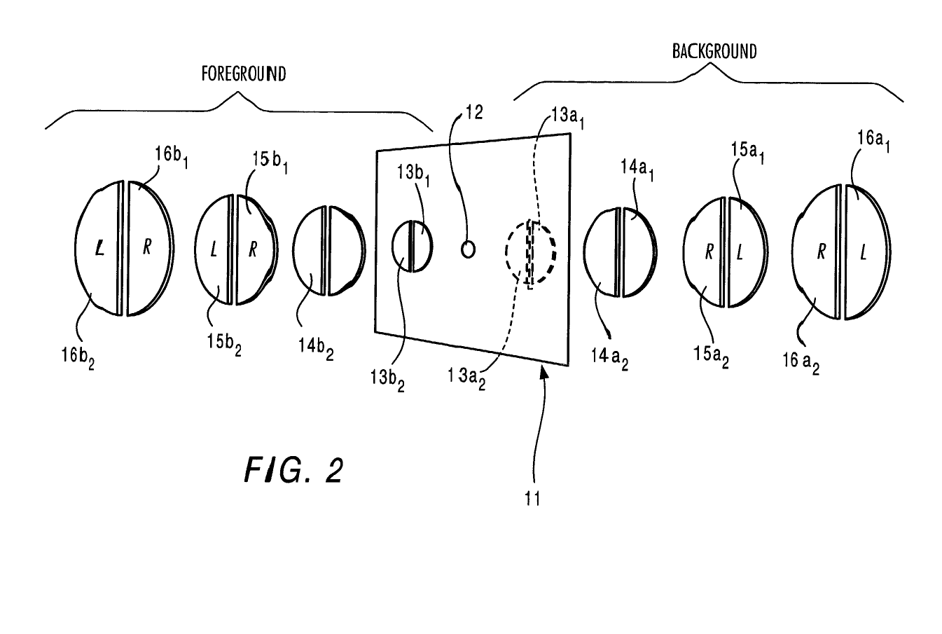

FIG. 2 shows each of the out of focus point images 13A through 16B of FIG. 1 divided, wherein the divisions are intended to represent the divisions resulting from step (d) above. In particular, the divisions of the point images 13A through 16B are along an axis that is both parallel to the image plane 11 and perpendicular to a line between a viewer's eyes. Thus, the image halves 13A₁ and 13A₂ are the two image halves (left and right respectively) of the background image point 13A. The image halves 13B₁ and 13B₂ show the divided left and right halves respectively of the foreground point image 13B wherein 13B₁ and 13B₂ are physically out-of-focus substantially the same as image halves 13A₁ and 13A₂. The left and right image halves 14A₁ and 14A₂ are visually out-of-focus and accordingly these image halves will be displayed selectively to the viewer's eyes as in step (e) above. That is, each of the viewer's eyes sees a different one of the image halves 14A₁ and 14A₂, and in particular, the viewer's right eye views only the left image half 14A₁ while the viewer's left eye views only the right image half 14A₂ as is discussed further immediately below. Thus, as indicated by the letter labels (FIG. 2) inside each half, the right eye view will be presented with the out-of-focus halves labeled with the letter “R” and the left eye view will be presented with the out-of-focus halves labeled with the letter “L”. Note that the side presented to an eye view is reversed depending on whether the foreground or background is being rendered.

Thus, in addition to the Steps (a) through (e) above, the present invention also performs an additional step (denoted herein as Step (e.1)) of determining which of the viewer's eyes is to receive each of the visually out-of-focus image halves. In this way the present invention provides the viewer with additional visual effects for indicating whether a visually out-of-focus portion of a scene or presentation is in the background or in the foreground. That is, for each pixel of IM from which a visually out-of-focus foreground portion of a scene is derived, the corresponding out-of-focus image halve are selectively displayed so that the left image half is displayed only to the viewer's right eye, and the right image half is displayed only to the viewer's left eye. Moreover for each pixel of IM from which a visually out-of-focus background portion of a scene is derived, the corresponding out-of-focus image halves are selectively displayed so that the left image half is displayed only to the viewer's left eye, and the right image half is displayed only to the viewer's right eye. Thus, for the left and right background image halves 16A₁ and 16A₂, each respectively is presented solely to the viewer's left and right eyes.

It is important to note that the enhanced three dimensional rendering system of the present invention, provided by Steps (a) through (e) and (e1), can be used with substantially any lens system (or simulation thereof). Thus, the invention may be utilized with lens systems (or graphical simulations thereof) where the focusing lens is spherically based, anamorphic, or some other configuration. Moreover, in one primary embodiment of the present invention, scenes from a modeled or artificially generate three dimensional world (e.g., virtual reality) are rendered more realistically to the viewer using digital eye wear (or other stereoscopic viewing devices) allowing each eye to receive concurrently a different digital view of a scene.

The present invention is also not limited to selectively providing half-circles to the viewer's eyes. Various other out-of-focus shapes (other than circles) may be divided in step (d) hereinabove. In particular, it has been demonstrated in the physical world that many other shapes will also produce the desired three dimensional image production and perception. For example, instead of being circular, the out-of-focus shapes may be rectangular, elliptical, asymmetric, or even disconnected. Thus, such out-of-focus shapes need not be symmetric, nor need they model out-of-focus light sources from the physical world. Moreover, it is believed that one skilled in the graphics software arts will easily see that most any method for achieving out-of-focus effect can be divided in some suitable way to achieve a stereoscopic result (from a non-stereoscopic image), and any such division is within the scoped of the present invention.

Moreover, note that in the dividing step (d) hereinabove, such left and right image “halves” need not be mirror images of one another. Furthermore, the left and right image halves need not have a common boundary. Instead, the right and left image halves may, in some embodiments, overlap, or have a gap between them.

Additionally, it is within the scope of the present invention to divide out-of-focus images and selectively display the resulting divided portions (e.g., image halves as discussed above) for only the foreground or only the background. Additionally, it is within the scope of the present invention to process only portions of either the background and/or the foreground such as the portions of a model space image within a particular distance of the object plane. For example, in modeling certain real world effects in computational systems, it may be unnecessary (and/or not cost effective) to apply the present invention to all out-of-focus regions.

Moreover, in Steps (a) through (e) and e(1) hereinabove, the out-of-focus image extent may be determined from an area larger than a pixel and/or the image IM (Step (a) above) may include pixels that themselves include portions of, e.g., both the background and the foreground.

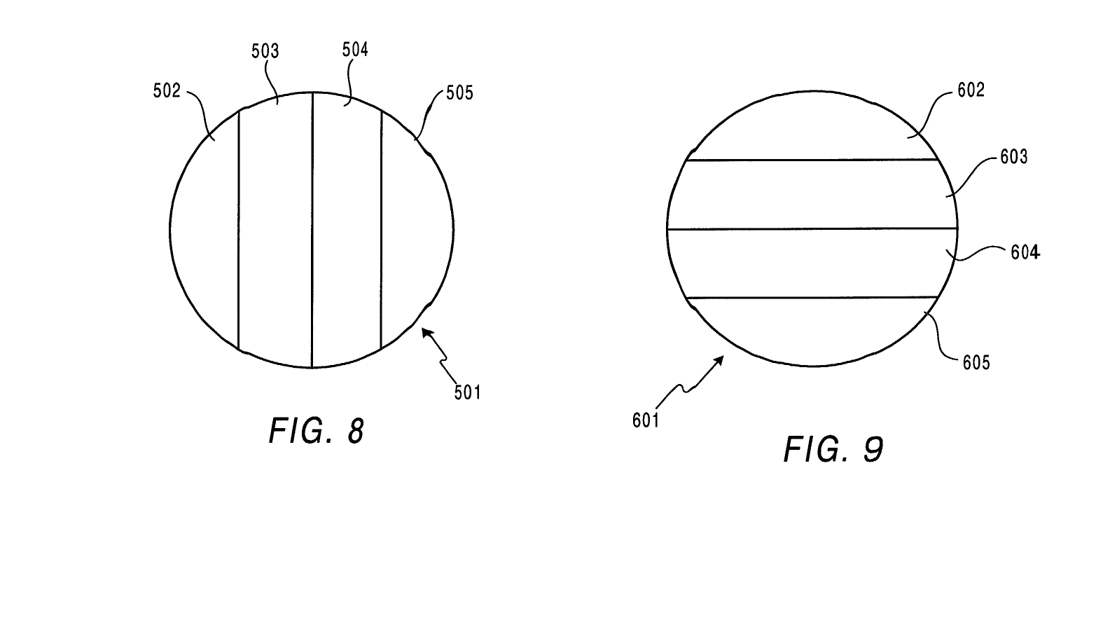

It is also worth noting that the present invention is not limited to only left and right eye stereoscopic views. It is well known that lenticular displays can employ multiple eye views. The division into left and right images halves as described hereinabove may be only a first division wherein additional divisions may also be performed. For example, as shown in FIG. 8, for each of one or more of the out-of-focus areas, such an area (labeled 501) can be divided into four vertical areas, thus creating the potential for four discrete views 502 through 505 for the pixel area 501 (instead of two “halves” as described hereinabove in Step (d)). Thus, those skilled in the software graphics arts will be readily able to extend the present invention to perform divisions (Step (d) hereinabove) to obtain as many out-of-focus image portions as are needed to satisfy particular display needs. Accordingly, the present invention includes substantially any number of vertical divisions of the image extents of pixels as in Step (d) above. Note that when there are multiple divisions in Step (d) above of an image extent of an IM pixel, then the rendering of the resulting image portions for enhanced three dimensional effects can be performed by an alternative embodiment of Step (e1) which receives three or more image portions of the out-of-focus IM pixel and then, e.g., performs the following substeps as referenced to FIG. 8:

1. For views V₁ through Vₙ (n>=2) of a pixel image extent obtained from dividing this extent (e.g., the views illustrated in FIG. 8 as views 502 through 505 with n=4), wherein these views correspond to multiple eye views from the viewer's far left to the far right field of view, determine whether a point for a view is a background or foreground point.

2. If the point for view Vₓ is a background point, return V₍ₙ₋ₓ₊₁₎. For example, a background point for view 505 would be 502.

3. If the point for view Vₓ is a foreground point Vₓ. For example, a foreground point for view 505 would be 505.

Additionally, note that horizontal divisions may also be provided in Step (d) above by embodiments of the invention, wherein the resulting horizontal “image portions” of the image extent of out-of-focus IM pixels are divided horizontal. In particular, such horizontal image portions, when selectively displayed to the to the viewer's eyes, can supply an enhanced three dimensional effect when a vertical head motion of the viewer is detected as one skilled in the art will understand. Note that for selective display of such horizontal image portions, Step (e1) may include the following substeps as illustrated by FIG. 9:

For views V₁ through Vₙ (n>=2) of a pixel image extent obtained from dividing this extent (e.g., the views illustrated in FIG. 9 as views 602 through 605 with n=4), wherein these views correspond to multiple eye views from the viewer's topmost to the bottom most field of view, determine whether a point for a view is a background or foreground point.

1. For views V₁ through Vₙ (n>=2) of a pixel image extent obtained from dividing this extent (e.g., the views illustrated in FIG. 9 as views 602 through 605 with n=4), wherein these views correspond to multiple eye views from the viewer's topmost to the bottom most field of view, determine whether a point for a view is a background or foreground point.

2. If the point for view Vₓ is a background point, return V₍ₙ₋ₓ₊₁₎ For example, a background point for 605 would be 602.

3. If the point for view Vₓ is a foreground point, return Vₓ. For example, a foreground point for view 605 would be 605.

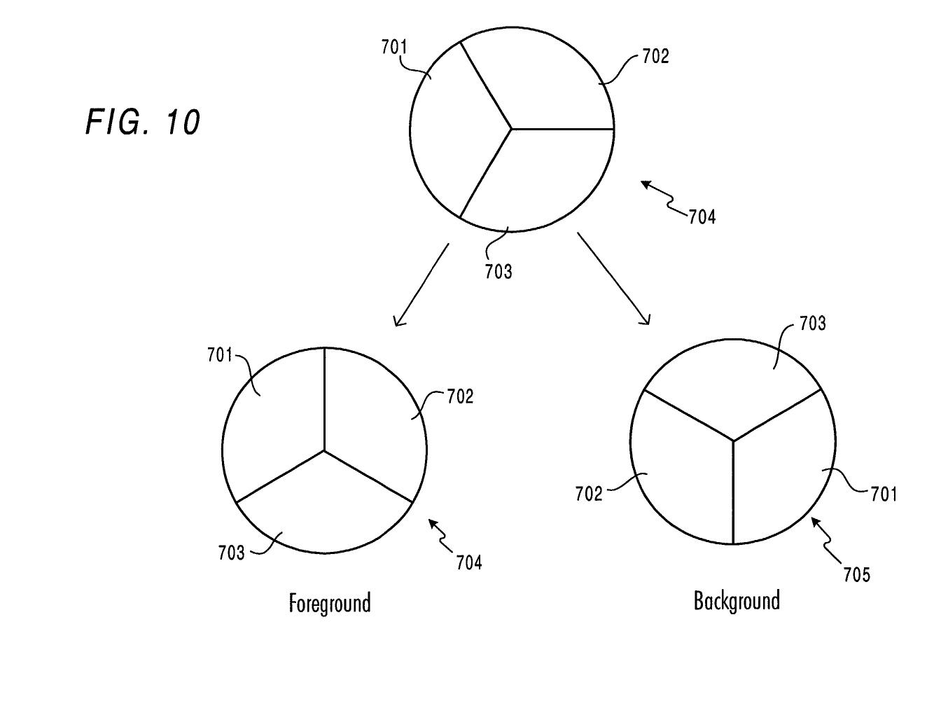

Moreover, it is within the scope of the present invention for Step (d) to divide IM out-of-focus pixels at other angles rather than vertical and horzontal. When Step (d) divides image extents at any angle, Step (e1) may include the following substeps, the general principals of which are illustrated in FIG. 10:

1. For views V₁ through Vₙ (n>=2) of a pixel image extent obtained from dividing this extent (e.g., the views illustrated in FIG. 10 as views 701 through 703), wherein these views correspond to multiple eye views rotationally symmetric around a center, determine whether a point for a view is a background or foreground point.

2. If the point for view Vₓ is a background point, invert both horizontally and vertically the reference as at 705, and return Vₓ. For example, a background point for view 703 would be determined by rotating horizontally and vertically the reference at 704 to yield a new reference at 705, and then to return 703 relative to the new reference.

3. If the point for view Vₓ is a foreground point, return Vₓ. For example, a foreground point for view 703 would use the unrotated reference at 704 and would return 703 relative to that reference.

Furthermore note that Step (d) may generate vertical, horizontal and angled divisions one the same IM out-of-focus pixels as one skilled in the art will understand

Furthermore note that when reference used and their inverted and reflected counterparts, it is preferable that each reference be calculated once and buffered thereafter. It is also preferred when using such an approach, that an identifier for the reference be returned rather than the input and a reference.

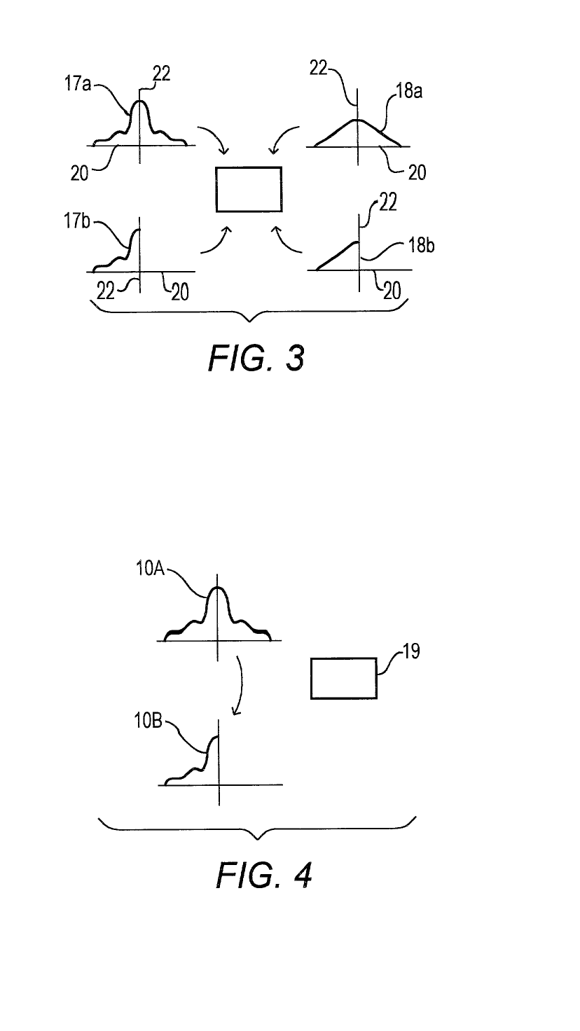

FIG. 3 shows graphical representations 17A and 18A of two formulas for determining how light goes out-of-focus as a function of distance from the object plane. In particular, the horizontal axis 20 of each of these graphs represents width of the out-of-focus area, and the vertical axis 22 represents the clarity of the image. More precisely, the vertical axis 22 describes may be considered as the intensity of action the image plane, and for each graph 17A and 18A, the respective portions to the left of its vertical axis is the graphical representation of how it is expected that light go out-of-focus for a viewer's eye while the portions of the vertical axis is the graphical representation of how it is expected that light go out-of-focus for a viewer's other eye. Note that the clarity measurement used on the vertical axes 22 may be described as follows: A narrow, tall graph represents a bright in-focus point, whereas a short, wide graph represents a dim, out-of-focus point. The vertical axis 22 in all graphs specifies spectral intensity values, and the horizontal axis 20 specifies the degree to which a point light source is rendered out-of-focus.

Referring now to graph 17A, this graph shows the graphic representation of the formula for a “circle of confusion” function, as one skilled in the optic arts will understand. The circle of confusion function can be represented by a formula that shows how light goes out-of-focus in the physical world. Referring now to graph 18A, this graph shows the graphic representation of a formula for “smearing” image components. Techniques that compute out-of-focus portions of images according to 18A are commonly used to suggest out-of-focus areas in a computer generated or computer altered image.

In the center of FIG. 3 is an advisory computational component 19 that may be used by the present invention for rendering foreground and background areas: image out-of-focus, smeared, shadowed, or otherwise different from the in-focus areas of the image plane. That is, the advisory computational component 19 performs at least Step (e) hereinabove. In particular it is believed that such an advisory computational component 19, wherein one or more selections are made regarding the type of rendering and/or the amount of rendering for imaging the foreground and background areas, has heretofore not been disclosed in the prior art. That is, between the “intention” to render and actualization of that rendering, such a selection process has here-to-fore never been made. In one embodiment of the advisory computational component, this component may determine answers to the following two questions for converting a non-stereoscopic view into a simulated stereoscopic view:

1. Is the point or area under query a background or a foreground point? and

2. Is the point or area under query a left eye view or a right eye view?

Accordingly, the advisory computational component 19 outputs a determination as to where to render the divided portions of step (d) above.

In one embodiment of the advisory computational component 19, this component may output a determination to render only the left image half (e semicircle as shown in FIG. 2). Accordingly, graph 17B shows the graphic representation of the formula for a “circle of confusion” function, where the decision was to render only such a left image half. Additionally, graph 18B shows the graphic representation of a formula for “smearing” out-of-focus portions of an image, wherein the decision was to render only the left image half according to a smearing technique.

FIG. 4 depicts an intention to render an out-of-focus point or region according to circle of confusion processing (i.e. represented by graph 10A) to the viewer's left eye without using the advisory component 19. However, to selectively render different image halves to different of the viewer's eyes requires at least one test and one branch. It is within the scope of the present invention to include all such tests and branches inside the component 19, where those tests and branches are used to determine a mapping between foreground and background and right and left views, and to a rendering technique (e.g., circle of confusion or smearing) that is appropriate.

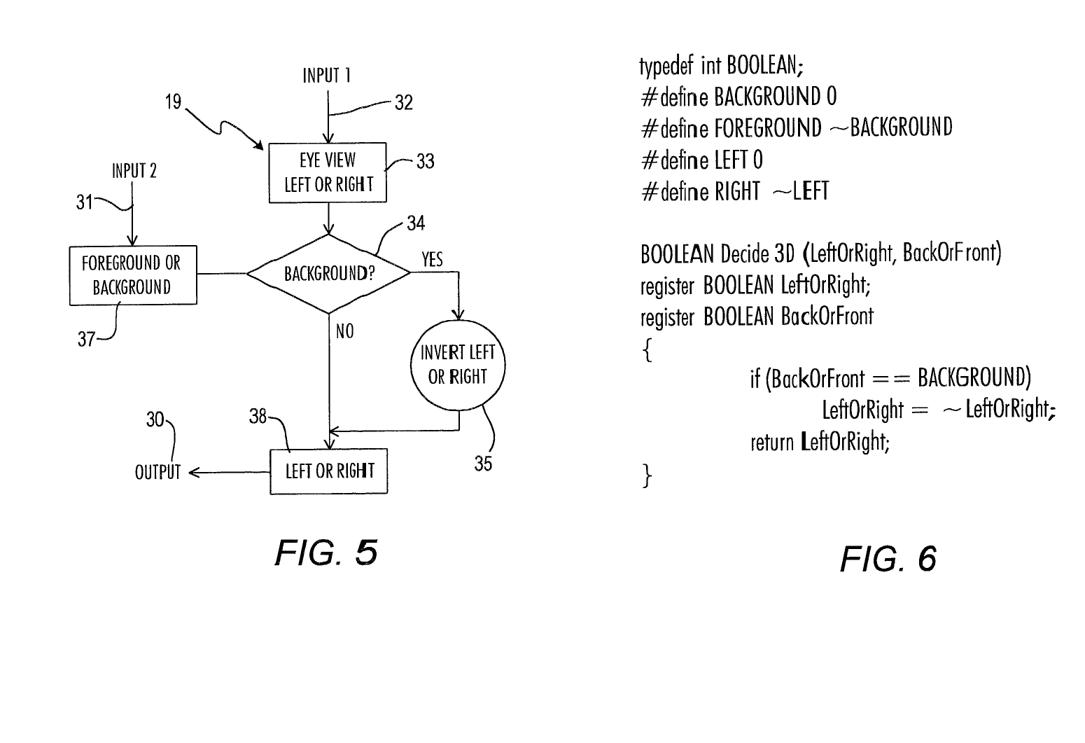

Note that there can be embodiments of the present invention wherein there is an attached data store for buffering or storing output rendering decisions generated by the advisory computational component 19, wherein such stored decisions can be returned in, e.g., a first-in-first-out order, or in a last-in-first-out order. For example, in multi-threaded applications, parallel processes may in a first instance seek to supply a module with points (e.g., IM pixels) to consider, and may in a second instance seek to use prior decided point information (e.g., image halves) to perform actual rendering. FIG. 5 shows an embodiment of the advisory computational component 19 at a high level. In this figure, two inputs, INPUT 1 and INPUT 2, are combined logically to produce one output 30. The output 30 indicates whether a currently being processed out-of-focus image of a model space image point is to be rendered as a left or right out-of-focus area. The INPUT 1 has one of two possible values, each value representing a different one of the viewer's eyes to which the output 30 is to be presented. In one embodiment, INPUT 1 may be, e.g., a Boolean expression whose value corresponds to which of the left and right eyes the output 30 is to be presented. Upon receipt of the INPUT 1, the advisory computational component 19 stores it in input register 33.

INPUT 2 also has one of two possible values, each value representing whether the currently being processed out-of-focus image is substantially of a model space image point (IP) in the foreground or in the background. In one embodiment, INPUT 2 may be, e.g., a Boolean expression whose value represents the foreground or the background. Upon receipt of the INPUT 2, the advisory computational component 19 stores it in the input register 37. Logic module 34 evaluates the two input registers, 33 and 37, periodically or whenever either changes. It either evaluates INPUT 2 in 37 for determining whether IP is: (i) a foreground IM pixel (alternatively, an IM pixel that does not contain any background), or (ii) an IM pixel containing at least some background. If the evaluation of INPUT 2 in register 37 results in a data representation for “FOREGROUND” (e.g., “false”), then INPUT 1 in register 33 is passed through to and stored in the output register 38 with its value (indicating which of the viewer's eyes IP is to be displayed) unchanged. If the evaluation in logic module 34 of INPUT 2 results in a data representation for “BACKGROUND” (e.g., “true”), then component 35 inverts the value of INPUT 1 so that if its value indicates presentation to the viewer's left eye then it is inverted to indicate presentation to the viewer's right eye and vise versa. Subsequently, the output of component 35 is provided to output register 38.

Note that the logic module 34 may only evaluate the two registers 33 and 37 whenever either one changes.

In one embodiment of the present invention for rendering of half-circular out-of-focus areas, the following table shows the four possible input states and their corresponding four output states.

I. Two Input versus One Output Logic

| INPUT 1 | INPUT 2 | OUTPUT | SHAPE |
|---|---|---|---|
| Left | Foreground | Left | Left half circle |
| Right | Foreground | Right | Right Half circle |
| Left | Background | Right | Right half circle |
| Right | Background | Left | Left half circle |

In an alternative embodiment of the advisory computation component 19, note that INPUT 2 may have more than two values. For example, INPUT 2 may present one of three values to the input register 37, i.e., values for foreground, background, and neither, wherein the latter value corresponds to each point (e.g., IM pixel) on the object plane, equivalently an in-focus point. Because a point on the object plane is in-focus, there is no reason to render it in either out-of-focus form.

Still referring to FIG. 5, any change to the contents of one of the input registers 33 and 37 is immediately reflected by a corresponding change in the output register 38. Clearly, anyone skilled in the software arts will realize that such input/output relationships can be asynchronous or clocked, and that they can be implemented in a number of variations, any of which will produce the same decision for producing enhanced three dimensional effects.

FIG. 6 shows an embodiment of the advisory computational component 19 coded in the C programming language. Such code can be compiled for installation into hardware chips. However, other embodiments of the advisory computational component 19 other than a C language implementation are possible.

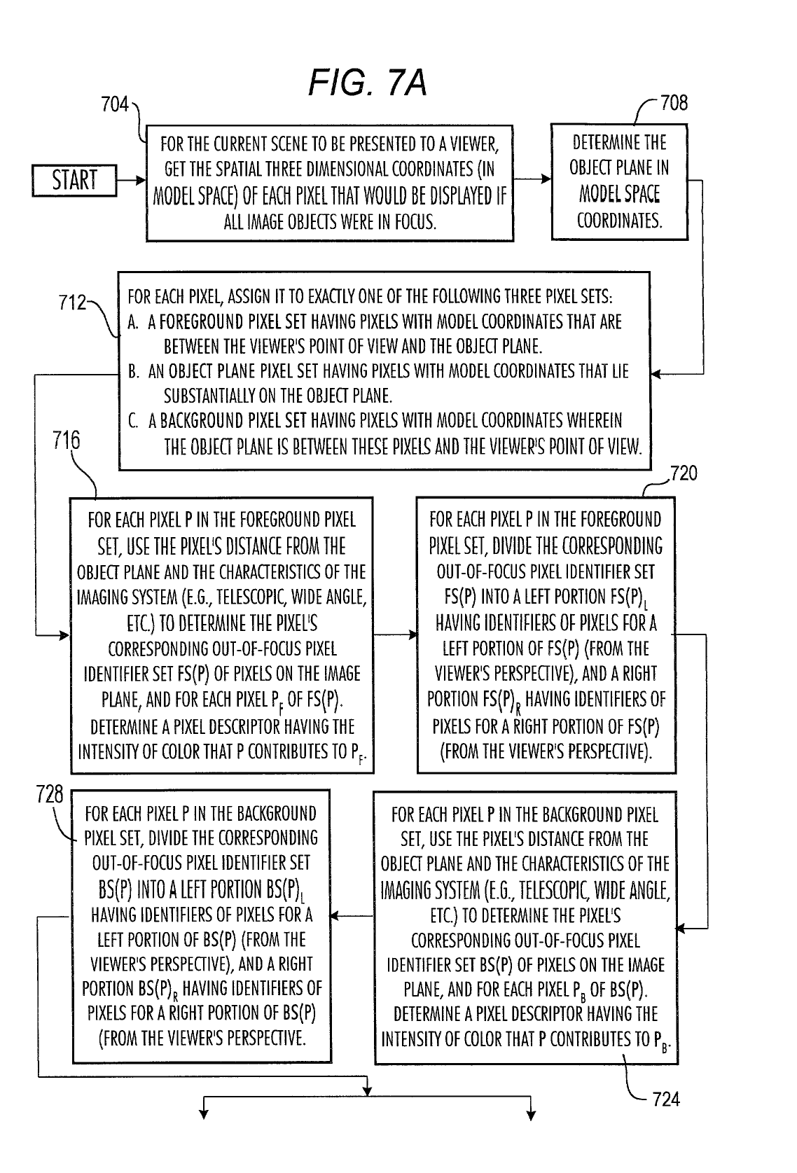

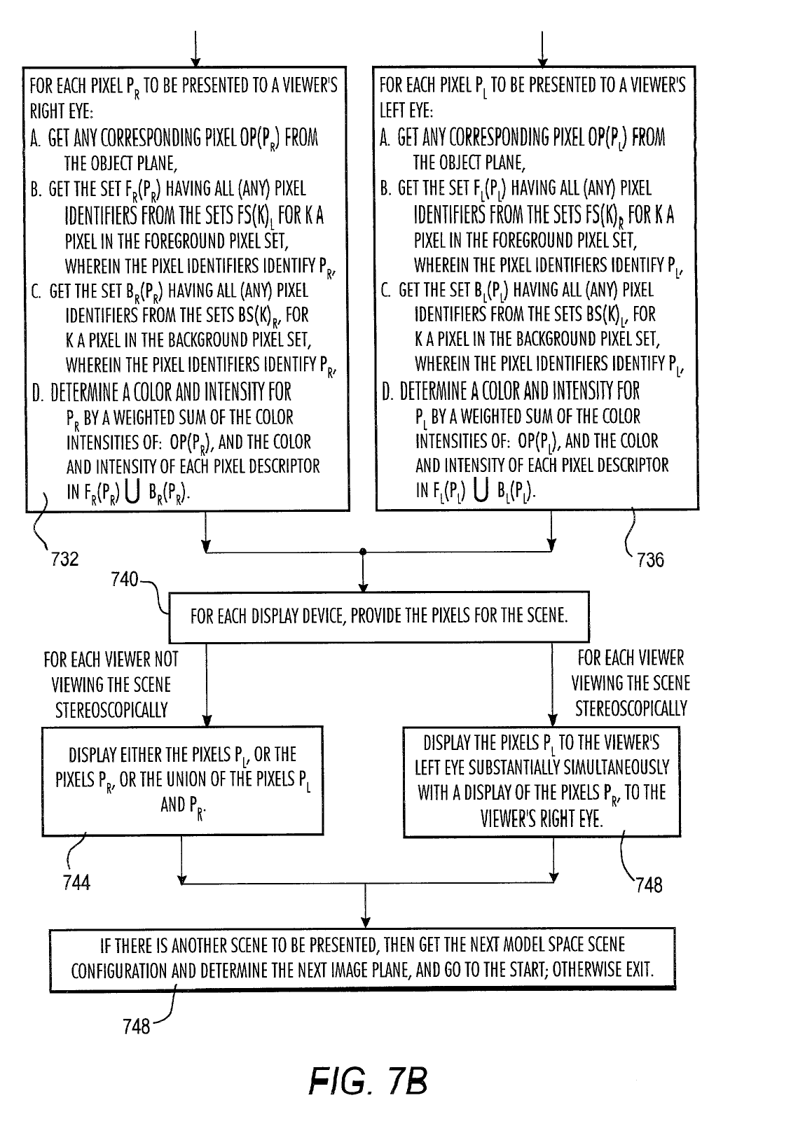

FIG. 7 is a high level flowchart the steps performed by at least one embodiment of the present invention for rendering one or more three dimensionally enhanced scenes. In step 704, the model coordinates of pixels for a “current scene” (i.e., a graphical scene being currently processed for defocusing the foreground and the background, and, adding three dimensional visual effects) are obtained. In step 708, a determination of the object plane in model space is made. In step 712, for each pixel in the current scene, the pixel (previously denoted IM pixel) is assigned to one of three pixel sets, namely:

1. A foreground pixel set having pixels with model coordinates that are between the viewer's point of view and the object plane;

2. An object plane set have pixels with model coordinates that lie substantially on the object plane; and.

3. A background pixel set have pixels with model coordinates wherein the object plane is between these pixels and viewer's point of view.

Subsequently, in step 716, for each pixel P in the foreground pixel set, determine the pixel's out-of-focus image extent on the image plane. That is, generate the set FS(P) of pixel identifiers for identifying each pixel on the image plane that will be effected by the defocusing of P. Note that this determination is dependent upon both the characteristics of the type of imaging being performed (such as telescopic, wide angle, etc.), and the distance that the pixel P is from the object plane. Additionally, for each image plane pixel PF identified in FS(P), determine a corresponding pixel descriptor having the spectral intensity of color that P (more precisely, the defocused extent of P) contributes to the pixel PF of the image plane.

In step 720, for each pixel P in the foreground pixel set, perform Step (d) previously described for dividing the corresponding out-of-focus image plane extent, FS(P), into, e.g., a left portion FS(P)L and a right portion FS(P)R (from the viewer's perspective).

In step 724, for each pixel P in the background pixel set, determine the pixel's out-of-focus image extent on the image plane. That is, generate the set BS(P) of pixel identifiers for identifying each pixel on the image plane that will be effected by the defocusing of P. Note that as with step 716, this determination is dependent upon both the characteristics of the type of imaging being performed (such as telescopic, wide angle, etc.), and the distance that the pixel P is from the object plane. Additionally, for each image plane pixel PB identified in BS(P), determine a corresponding pixel descriptor having the spectral intensity of color that P (more precisely, the focused extent of P) contributes to the pixel PB of the image plane.

In step 728, for each pixel P in the background pixel set, perform Step (d) previously described for dividing the corresponding out-of-focus image plane extent, BS(P), into, e.g., a left portion BS(P)L and a right portion BS(P)R (from the viewer's perspective).

Subsequently, steps 732 and 736 are performed (parallelly, asynchronously, or serially). In step 732, a version of the current scene (i.e., a version of the image plane) is determined for displaying to the viewer's right eye and in step 736, a version of the current scene (i.e., also a version of the image plane) is determined for displaying to the viewer's left eye. In particular, in step 732, for determining each pixel P_{R} to be presented to the viewer's right eye, the following substeps are performed:

732(a) Determine any corresponding pixel OP(P_{R}) from the object plane that corresponds to the display location of P_{R};

732(b) Obtain the set FR(PR) having all (i.e., zero or more) pixel identifiers, ID, for the from the left portion sets FS(K)_{L} for K a pixel in the foreground pixel set, wherein each of the pixel identifiers ID identify the pixel PR. Note that each FS(K)_{L} is determined in step 720;

732(c) Obtain the set B_{R}(P_{R}) having all (i.e., zero or more) pixel identifiers, ID, from the right portion sets BS(K)_{R} for K a pixel in the background pixel set, wherein each of the pixel identifiers ID identify the pixel P_{R}. Note that each BS(K)_{R} is determined in step 728; and

732(d) Determine a color and intensity for P_{R} by computing a weighted sum of the color intensities of: OP(P_{R}), and the color and intensity of each pixel descriptor in F_{R}(P_{R})∪B_{R}(P_{R}). In at least one embodiment, the weighted sum is determined so that the resulting spectral intensity of P_{R} is substantially the same as the initial spectral intensity of the uniquely corresponding pixel from model space prior to any defocusing. Thus, for example, assume the pixel display location of P_{R} (on the image plane) is a unique projection of a background pixel Pₘ in model space prior to any defocusing, and Pₘ has a spectral intensity of 66 (on a scale of, e.g., 0 to 256). Also assume that it is determined (in step 720) that there are two background left portion sets BS(K₁)_{L} and BS(K₂)_{L} having, respectively, pixel identifiers ID₁ and ID₂ each identifying the image plane location of P_{R}, and that the spectral intensity contribution to the pixel location of P_{R} from the (model space) 20pixels identified by ID₁ and ID₂ is respectively 14 and 23. Further, assume that there is one background right portion set BS(K₃)_{R} (determined in step 728) having a pixel identifier ID₃ also identifying the image plane location of P_{R} wherein the spectral intensity contribution of the pixel location of P_{R} is 55. Then the color and spectral intensity of P_{R} is:

$$66 * ( \frac{66}{158} * {c}_{m} + \frac{14}{158} * {c}_{1} + \frac{23}{158} * {c}_{2} + \frac{55}{158} * {c}_{3} ) ,$$

wherein 66+14+23+55=158 and cₘ, c₁, c₂, and c₃ are the color designations for Pₘ, K₁, K₂, and K₃.

Note that step 736 can be described similarly to step 732 above by merely replacing “R” subscripts with “L” subscripts, and “L” subscripts with “R” subscripts.

In step 740 the pixels determined in steps 732 and/or 736 are supplied to one or more viewing devices for viewing the current scene by one or more viewers. Note that such display devices may include stereoscopic and non-stereoscopic display devices. In particular, for viewers viewing the current scene non-stereoscopically, step 744 is performed wherein the display device either displays only the pixels determined by one of the steps 732 and 736, or alternatively both right eye and left eye versions of the current scene may be displayed substantially simultaneously (e.g., by combining the right eye and left eye versions as one skilled in the art will understand). Note, however, that the combining of the right eye and left eye versions of the current scene may also be performed in step 740 prior the transmission of any current scene data to the non-stereoscopic display devices.

Concurrently with step 744, step 748 is performed for providing current scene data to each stereoscopic display device to be used by some viewer for viewing the current scene. However in this step, the pixels determined in step 732 are provided to the right eye of each viewer and the pixels determined in step 736 are provided the left eye of each viewer. In particular, for each viewer, the viewer's right eye is presented with the right eye version of the current scene substantially simultaneously with the viewer's left eye being presented with the left eye version of the current scene (wherein “substantially simultaneously” implies, e.g., that the viewer can not easily recognize any time delay between displays of the two versions).

Finally, in step 748 a determination is made as to whether there is another scene to convert to provide an enhanced three dimensional effect according to the present invention.

The foregoing discussion of the invention has been presented for purposes of illustration and description. Further, the description is not intended to limit the invention to the form disclosed herein. Consequently, variation and modification commiserate with the above teachings, within the skill and knowledge of the relevant art, are within the scope of the present invention. The embodiment described hereinabove is further intended to explain the best mode presently known of practicing the invention and to enable others skilled in the art to utilize the invention as such, or in other embodiments, and with the various modifications required by their particular application or uses of the invention.

What is claimed is:

1. A method for rendering a stereoscopic view of an image, comprising:
providing an image, the image including an out-of-focus image representation of an object in the image;
selecting a first part of the out-of-focus image representation and a second part of the out-of-focus image representation: and
presenting, at least substantially simultaneously, the first part to a first eye of a viewer and a second part to a second eye of the viewer that is different from the first eye.

2. The method of Claim 1, wherein the providing step includes the step of:
determining an image plane, wherein the projection of each object on the image plane is in-focus regardless of the object's distance from a point of view of the viewer.

3. The method of claim 2, wherein the providing step further includes the step of:
determining an object plane in a model space that is at least substantially parallel to the image plane.

4. The method of claim 3, wherein the providing step further includes the step of:
determining an out-of-focus image extent of at least a first pixel in the image plane based on a distance of the at least a first pixel from the object plane; and
assigning to the at least a first pixel a value based on the at least a first pixel being in front of or behind the object plane relative to the point of view of the viewer.

5. The method of claim 1, wherein in the selecting step the first and second parts are portions of the same object image.

6. The method of claim 4, wherein the first and second parts are portions of the out-of-focus image extent of the at least a first pixel.

7. The method of claim 6, wherein the presenting step includes the steps of:
prohibiting the first part from being viewed by the second eye of the viewer; and
prohibiting the second part from being viewed by the first eye of the viewer.

8. The method of claim 1, wherein the providing step includes the step of:
determining first coordinates in an at least three dimensional model space of at least a first object pixel, the first object pixel being a representation of at least a portion of the image that would be displayed if all objects in the image were in focus.

9. The method of claim 8, wherein the providing step further includes the step of:
determining coordinates of an object plane in the at least three dimensional model space.

10. The method of claim 9, wherein the selecting step includes the step of:
assigning the first object pixel to one of a foreground pixel set, an object plane pixel set, or a background pixel set, wherein the foreground pixel set includes object pixels having coordinates in the at least three dimensional model space that are located between the viewer's point of view and the object plane, the object plane pixel set includes object pixels having coordinates in the at least three dimensional model space that are located at least substantially in the object plane, and the background pixel set includes object pixels having coordinates in the at least three dimensional model space such that the image plane is located between the object pixels in the background pixel set and the viewer's point of view.

11. The method of claim 10, wherein the selecting step further includes the step of:
when the first object pixel is in the foreground pixel set, assigning, based on the first object pixel's distance from the object plane and a characteristic of an imaging system, the first object pixel to a corresponding out-of-focus pixel identifier set, the out-of-focus pixel identifier set including for each out-of-focus object pixel in the foreground pixel set a corresponding image pixel on the image plane; and
determining, for at least a first image pixel, an image pixel descriptor having an intensity of color that the at least a first image pixel contributes to the intensity of color of the corresponding first object pixel in the out-of-focus pixel identifier set.

12. The method of claim 11, wherein the selecting step further includes the step of:
when the first object pixel is in the foreground pixel set, dividing the corresponding out-of-focus pixel identifier set into the first part, the first part having identifiers of image pixels for the left part of the foreground pixel set as viewed by the viewer and the second part, the second part having identifiers of image pixels for the right part of the foreground pixel set as viewed by the viewer.

13. The method of claim 12, wherein the selecting step further includes the step of:
when the first pixel is in the background pixel set, assigning, based on the first object pixel's distance from the object plane and a characteristic of an imaging system, the first object pixel to the corresponding out-of-focus pixel identifier set, the out-of-focus pixel identifier set including for each out-of-focus object pixel in the background pixel set a corresponding image pixel on the image plane; and
determining for at least the first object pixel the pixel descriptor having an intensity of color that the first object pixel contributes to the intensity of color of the corresponding image pixel in the out-of-focus pixel identifier set.

14. The method of claim 13, wherein the selecting step further includes the step of:
when the first object pixel is in the background pixel set, dividing the corresponding out-of-focus pixel identifier set into the first part, the first part having identifiers of image pixels for the left part of the background pixel set as viewed by the viewer and the second part, the second part having identifiers of image pixels for the right part of the background pixel set as viewed by the viewer.

15. The method of claim 14, wherein the presenting step includes, for each first pixel to be presented to the first eye, the steps of:
retrieve any object pixel from the object plane that corresponds to the first pixel;
for each object pixel corresponding to the first pixel, determining the corresponding image pixel in the foreground pixel set and the corresponding second part of the corresponding image pixel;
for each object pixel corresponding to the first pixel, determining the corresponding image pixel in the background pixel set and the corresponding first part of the corresponding image pixel; and
assigning the corresponding second part of the foreground pixel set and the corresponding first part of the background pixel set to a first eye pixel set.

16. The method of claim 15, wherein the presenting step includes, for each first pixel to be presented to the first eye, the steps of:
determining a color and intensity for the first pixel by a weighted sum of (a) the colors and intensities of the object pixels corresponding to the first pixel and (b) 5 the colors and intensities of each pixel descriptor in the union of the second part of the out-of-focus pixel identifier set corresponding to the respective image pixels in the foreground pixel set and of the first part of the out-of-focus pixel identifier set corresponding to the respective image pixels in the background pixel set.

17. A system for rendering a stereoscopic view of an image, the image including an out-of-focus image representation of an object in the image and an in-focus image representation of an object in the image, the system comprising,
selecting means for selecting a first part of the out-of-focus image representation and a second part of the out-of-focus image representation: and
display means for displaying, at least substantially simultaneously, the first part to a first eye of a viewer and a second part to a second eye of the viewer that is different from the first eye.

18. The system of claim 17, wherein the selecting means comprises:
first determining means for determining an image plane of a model space, wherein the projection of each object on the image plane is in-focus regardless of the object's distance from a point of view of the viewer.

19. The system of claim 18, wherein the selecting means comprises:
second determining means for determining an object plane that is at least substantially parallel to the image plane.

20. The system of claim 19, wherein the selecting means comprises:
third determining means for determining an out-of-focus image extent of at least a first pixel in the image plane based on a distance of the at least a first pixel from the object plane; and
assigning means for assigning to the at least a first pixel a value based on the at least a first pixel being in front of or behind the object plane relative to the point of view of the viewer.

21. The system of claim 17, wherein the first and second parts are portions of the same object image.

22. The system of claim 20, wherein the first and second parts are portions of the out-of-focus image extent of the at least a first pixel.

23. The system of claim 20, wherein the displaying means further includes:
first prohibiting means for prohibiting the first part from being viewed by the second eye of the viewer; and
second prohibiting means for prohibiting the second part from being viewed by the first eye of the viewer.

24. A system for rendering a stereoscopic view of an image, the image including an out-of-focus image representation of an object in the image and an in-focus image representation of an object in the image, the system comprising,
a processor for selecting a first part of the out-of-focus image representation and a second part of the out-of-focus image representation: and
a display for displaying, at least substantially simultaneously, the first part to a first eye of a viewer and a second part to a second eye of the viewer that is different from the first eye.

25. The system of claim 24, wherein the processor comprises:
a first computational component for determining an image plane of a model space, wherein the projection of each object on the image plane is in-focus regardless of the object's distance from a point of view of the viewer.

26. The system of claim 25, wherein the processor comprises:
a second computational component for determining an object plane that is at least substantially parallel to the image plane.

27. The system of claim 26, wherein the processor comprises:
a third computational component for determining an out-of-focus image extent of at least a first pixel in the image plane based on a distance of the at least a first pixel from the object plane; and
a fourth computational component for assigning to the at least a first pixel a value based on the at least a first pixel being in front of or behind the object plane relative to the point of view of the viewer.

28. The system of claim 27, wherein the first and second parts are portions of the same object image.

29. The system of claim 27, wherein the first and second parts are portions of the out-of-focus image extent of the at least a first pixel.

30. The system of claim 27, wherein the processor includes:
a fifth computation component for prohibiting the first part from being viewed by the second eye of the viewer; and
a sixth computation component for prohibiting the second part from being viewed by the first eye of the viewer.
